(19) United States
(12) Patent Application Publication
(10) Pub. No.: US 2003/0142452 A1
(43) Pub. Date: Jul. 31, 2003

(54) Protective circut for a breaker gap

(76) Inventors: Peter Heider, Schwandorf (DE); Norbert Mitlmeier, Ursensollen (DE); Diethard Ringgaldier, Stegaurach (DE); Johann Seitz, Amberg (DE); Bernhard Streich, Amberg (DE)

Correspondence Address: HARNESS, DICKEY & PIERCE, P.L.C., P.O.BOX 8910, RESTON, VA, 20195, US

(21) Appl. No.: 10/296,176

(22) PCT Filed: May 9, 2001
(86) PCT No.: PCT/DE01/01761

(30) Foreign Application Priority Data
May 22, 2000 (DE) 100 25 276.1

(51) Int. Cl. H01H 83/00

(52) U.S. Cl. 361/103; 335/20

(57) ABSTRACT

The invention relates to a protective circuit for a breaker gap (2), said gap being used to connect a load voltage (UL) to a load (1). The circuit is characterized in that a voltage detection circuit (3) is connected to a detection point (4) on the input side and a detection point on the output side of the breaker gap (2), via detection resistances (R1) said voltage detection circuit (3) being connected to the detection points (4) at high-resistance but in a permanently galvanized manner.

This application is the national phase under 35 U.S.C. § 371 of PCT International Application No. PCT/DE01/01761 which has an International filing date of May 9, 2001, which designated the United States of America and which claims priority on German Patent Application number DE 100 25 276.1 filed May 22, 2000, the entire contents of which are hereby incorporated herein by reference.

### FIELD OF THE INVENTION

The present invention generally relates to a circuit for a circuit-breaker gap. Preferably, it relates to one by way of which a load voltage can be applied to a load, with a voltage detection circuit being connected via detection resistors to an input-side and to an output-side detection point of the circuit-breaker gap.

### BACKGROUND OF THE INVENTION

A circuit is known, for example, from U.S. Pat. No. 4,298,810.

U.S. Pat. No. 4,777,479 likewise discloses a circuit for a circuit-breaker gap, by means of which a load voltage can be applied to a load. In this circuit, a voltage detection circuit is conductively permanently connected via voltage divider resistors to an input-side detection point and directly to an output-side detection point of the circuit-breaker gap.

Circuits are used, for example, in contactors in order to detect an arc voltage which occurs when the contactor is switched off. In the prior art, the voltage detection circuit is in this case connected via an electromechanical auxiliary switch to the detection points of the circuit-breaker gap. The output signal from the voltage detection circuit is passed to an evaluation circuit, which is connected for signaling purposes, generally via an optocoupler, to the voltage detection circuit.

The circuit from the prior art is comparatively expensive. However, it is regarded as being essential owing to the DC isolation that is achieved and the direct contact protection provided in the process.

### SUMMARY OF THE INVENTION

An object of an embodiment of the present invention is to provide a circuit for a circuit-breaker gap which can be produced relatively cost-effectively and in which there is nevertheless no hazard to personnel or downstream circuits.

An object may be achieved by the voltage detection circuit being connected with a high impedance, but conductively permanently, to the detection points.

If the detection resistors have the same resistance values, the voltage detection is particularly reliable and accurate.

An object may be achieved by the detection resistors having the same resistance values, which are greater than 1 Megaohm.

If the voltage detection circuit is in the form of an operational amplifier, this results in a high signal quality.

If in each case, one of the detection resistors is connected to a respective inverting signal input or to a non-inverting signal input of the operational amplifier and the signal inputs are connected via circuit resistors to a reference voltage and, respectively, to a signal output of the operational amplifier, the signal which is emitted and represents the detected voltage is particularly stable.

If the operational amplifier is supplied with a supply voltage and the reference voltage is half the supply voltage, this results in a particularly wide detection range—particularly when the load voltage is an AC voltage.

If the inverting signal input is connected via a first diode circuit to the reference voltage and/or the circuit resistor which is connected to the non-inverting signal input is connected in parallel with a second diode circuit, the signal which is emitted from the voltage detection circuit is limited.

If the circuit resistors are connected in parallel with capacitors, this results in the voltage detection circuit having a better dynamic response.

The high-impedance connection of the voltage detection circuit to the detection points makes it possible for the voltage detection circuit to be connected to the evaluation circuit not only for signaling purposes but even conductively and permanently.

If the evaluation circuit has a window comparator which is connected to the voltage detection circuit, the further evaluation of the detected voltage signal is particularly simple.

The circuit-breaker gap may optionally be in the form of a mechanical contact (contactor or isolating switch) or in the form of an electronic switch (bipolar transistor, IGBT, MOSFET, thyristor, GTO etc.).

### BRIEF DESCRIPTION OF THE DRAWINGS

Further advantages and details can be found in the following description of an exemplary embodiment. In this case, in the outline illustration, the single figure shows:

FIG. 1 shows a circuit for a circuit-breaker gap.

### DETAILED DESCRIPTION OF THE PREFERRED EMBODIMENTS

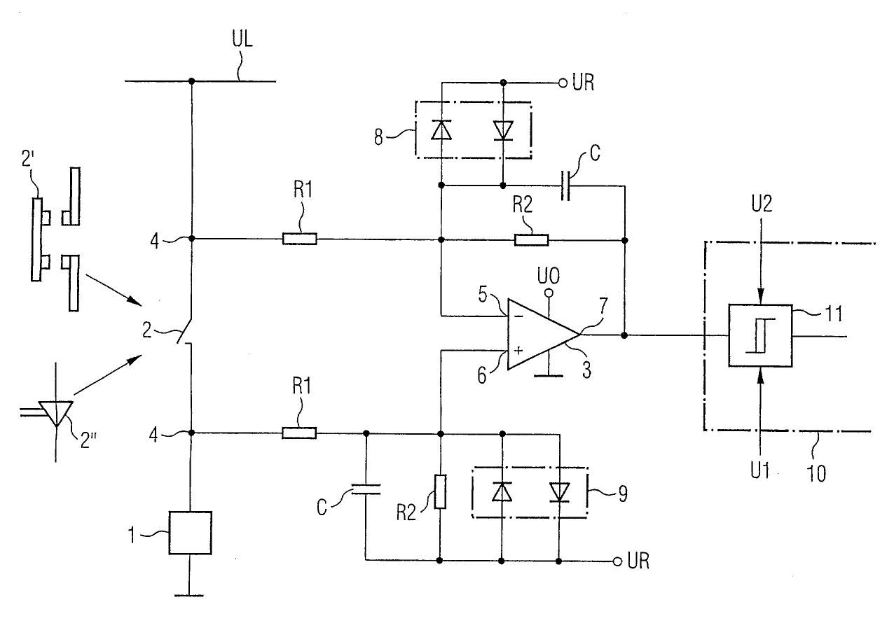

As shown in FIG. 1, a load 1 can be connected to a load voltage UL via a circuit-breaker gap 2. The circuit-breaker gap 2 may optionally be in the form of a mechanical contact 2′ or in the form of an electronic switch 2″. Examples of a mechanical contact 2′ include a contact in a contactor or a contact in an isolating switch. Examples of an electronic switch are IGBT and GTO thyristors. The circuit which is described in the following text can be used in particular for mechanical contacts 2′ in all voltage ranges and for electronic switches 2″ for the high-voltage range (>1000 volts).

As shown in FIG. 1, a voltage detection circuit 3 is connected via detection resistors R1 to detection points 4. One of the detection points 4 is in this case respectively arranged on the input side and output side of the circuit-breaker gap 2. The voltage detection circuit 3 is connected via the detection resistors R1 to the detection points 4 with a high impedance, but conductively and permanently.

The detection resistors R1 have resistance values which are typically in the range above 1 Megaohm, for example 3 to 10 Megaohms. They preferably have the same resistance values.

The voltage detection circuit 3 is in the form of an operational amplifier 3 and has an inverting signal input 5, a non-inverting signal input 6 and a signal output 7. The operational amplifier 3 is supplied with a supply voltage U0.

As can be seen, the signal inputs 5, 6 are connected to the detection points 4 via the detection resistors R1. The inverting signal input 5 is also connected via a parallel circuit, which is formed from a circuit resistor R2 and a capacitor C, to the signal output 7. The non-inverting signal input 6 is connected via a further parallel circuit, which is likewise formed from a circuit resistor R2 and a capacitor C, to a reference voltage UR.

In principle, any desired reference voltage UR may be chosen. However, it is preferably half the supply voltage U0.

The circuit resistors R2 are considerably smaller than the detection resistors R1. Their resistance values are typically in the range <10 kiloohms-, for example 1 to 5 kiloohms. Like the detection resistors R1, they preferably have the same resistance value.

The capacitors C preferably have a relatively small capacitance, for example 10-470 nF.

According to FIG. 1, the inverting signal input 5 is connected via a first diode circuit 8 to the reference voltage UR. The circuit resistor R2, which is connected to the non-inverting signal input 6, is furthermore connected in parallel with a second diode circuit 9. The diode circuits 8, 9 each have two back-to-back parallel-connected diodes. The diode circuits 8, 9 are preferably designed to be identical to one another.

The circuit of the operational amplifier 3 means that the reference voltage UR is produced at the signal output 7 of the operational amplifier 3 when the circuit-breaker gap 2 is closed. In contrast, when the circuit-breaker gap 2 is opened, the load voltage UL, or an arc voltage if appropriate, is dropped across it. The signal which is emitted from the signal output 7 is thus changed upward or downward.

The signal output 7 of the operational amplifier 3 is connected, for signaling purposes, to an evaluation circuit 10, in the present case even conductively permanently. The evaluation circuit 10 has at least one window comparator 11, to which comparison voltages U1, U2 are supplied. The two comparison voltages U1, U2 are slightly greater than or less than the reference voltage UR. The window comparator 11 produces a positive output signal when the voltage emitted at the signal output 7 of the operational amplifier 3 is within the voltage window defined by the comparison voltages U1, U2. Otherwise it produces a zero signal.

The circuit according to an embodiment of the invention makes it possible to detect the voltage dropped across the circuit-breaker gap 2 in a simple, cost-effective and reliable manner. The power loss which occurs in the circuit is in this case completely negligible.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A circuit for a circuit-breaker gap (2), by means of which a load voltage (UL) can be applied to a load (1), with a voltage detection circuit (3) being conductively permanently connected via a first detection resistor (R1) to an input-side detection point (4) and via a second detection resistor (R1) to an output-side detection point (4) of the circuit-breaker gap (2),
characterized
in that the detection resistors (R1) have the same resistance values, which are greater than 1 megaohm.

2. The circuit as claimed in claim 1,
characterized
in that the voltage detection circuit (3) is in the form of an operational amplifier (3).

3. The circuit as claimed in claim 2,
characterized
in that in each case one of the detection resistors (R1) is connected to an inverting signal input (5) or to a non-inverting signal input (6) of the operational amplifier (3), and in that the signal inputs (5, 6) are connected via circuit resistors (R2) to a reference voltage (UR) and, respectively, to a signal output (7) of the operational amplifier (3).

4. The circuit as claimed in claim 3,
characterized
in that the circuit resistors (R2) have the same resistance values.

5. The circuit as claimed in claim 3 or 4,
characterized
in that the operational amplifier (3) is supplied with a supply voltage (U0), and in that the reference voltage (UR) is half the supply voltage (U0).

6. The circuit as claimed in claim 3, 4 or 5,
characterized
in that the inverting signal input (5) is connected via a first diode circuit (8) to the reference voltage (UR)

7. The circuit as claimed in one of claims 3 to 6,
characterized
in that the circuit resistor (R2) which is connected to the non-inverting signal input (6) is connected in parallel with a second diode circuit (9).

8. The circuit as claimed in one of claims 3 to 7,
characterized
in that the circuit resistors (R2) are connected in parallel with capacitors (C).

9. The circuit as claimed in one of claims 1 to 8,
characterized
in that the voltage detection circuit (3) is connected, for signaling purposes, to an evaluation circuit (10).

10. The circuit as claimed in claim 9,
characterized
in that the voltage detection circuit (3) is conductively permanently connected to the evaluation circuit (10).

11. The circuit as claimed in claim 9 or 10,
characterized
in that the evaluation circuit (10) has a window comparator (11) which is connected to the voltage detection circuit (3).

12. The circuit as claimed in one of claims 1 to 11,
characterized
in that the circuit-breaker gap (2) is in the form of a mechanical contact (2′).

13. The circuit as claimed in one of claims 1 to 11,
characterized
in that the circuit-breaker gap (2) is in the form of an electronic switch (2′).
